(19) United States
(12) Patent Application Publication
(10) Pub. No.: US 2007/0014217 A1
(43) Pub. Date: Jan. 18, 2007

(54) Method of determining optimum recording power and optical disc recording/reproducing apparatus using the same

(75) Inventors: Kang-uk Cho, Suwon-si (KR); Shuichi Tasaka, Suwon-si (KR); Wook-yeon Hwang, Seoul (KR); Yong-jin Ahn, Seoul (KR); Jong-kyu Kim, Suwon-si (KR); Chi-ho Lee, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/485,461

(22) Filed: Jul. 13, 2006

(30) Foreign Application Priority Data
Jul. 13, 2005 (KR) 2005-63429

(51) Int. Cl. G11B 19/00

(52) U.S. Cl. 369/47.5

(57) ABSTRACT

A method of determining an optimum recording power with respect to a rewritable optical recording medium with multiple layers. The method includes the operations of writing a recording signal to an unrecorded area of a power calibration area (PCA) of the rewritable optical recording medium using a predetermined recording power, and measuring characteristics of the recording signal, determining whether the measured recording signal characteristics have a saturation area, computing a recording power at a saturation point of the recording signal characteristics when the recording signal characteristics have the saturation area, and determining an optimum recording power by multiplying the recording power at the saturation point by a predetermined value. An optimum recording power is determined by using the saturation point of the recording signal characteristic curve such that optimum recording power can be accurately obtained when the optimum recording power is in the saturation area.

### CROSS-REFERENCE TO RELATED APPLICATION

This application claims benefit under 35 U.S.C. § 119 from Korean Patent Application No. 2005-63429, filed Jul. 13, 2005 in the Korean Intellectual Property Office, the disclosure of which is incorporated herein by reference.

### BACKGROUND OF THE INVENTION

1. Field of the Invention

Aspects of the present invention relate to a method of determining optimum recording power using saturation characteristics of a recording signal, and an optical recording/reproducing apparatus applied to the same.

2. Description of the Related Art

An optical recording medium is generally classified into a read-only memory (ROM), a write-only-read memory (WORM), and a rewritable medium. An example of a rewritable medium is a Re-writable Digital Versatile disc (DVD-RW). The recording area of the DVD-RW disc comprises a recording information area (RIA) and an information area. The RIA comprises a power calibration area (PCA) and a recording management area (RMA) for use in obtaining an optimum recording power. The information area comprises a lead-in area, a data recording area, and a lead-out area.

Before writing/recording, any data to the recording area of an optical disc, an optical recording/reproducing apparatus performs optimum power calibration (OPC) in the PCA of the optical disc. The process of OPC determines an optimum recording power to bring in an optimum recording signal in the PCA to calibrate the recording power to record data in the optical disc.

Laser recording power is calibrated in consideration of such factors as recording sensitivity of the optical disc layer, temperature, and changes of laser wavelength. Data is recorded at varying laser powers, and the optimum recording power to bring in the optimum recording signal is determined. The OPC is performed in a block-wise basis, and the PCA blocks with no previous OPC operation are first selected for the OPC.

FIGS. 1A and 1B illustrate a method of determining the optimum recording power using a linear area of a signal characteristic curve. FIG. 1A shows the relation between recording power and jitter, and FIG. 1B shows characteristics of the recording power and a recording signal. Referring to FIG. 1A, the optimum recording power Po is set when the jittering is at a minimum level. The jitter indicates an error of read signals (i.e., RF signals) reproduced from an optical disc. The jitter represents as a figure the difference between the binarized RF signal and integer multiples of a pit length of the optical disc.

Referring to FIG. 1B, if the optimum recording power is in the linear area of the signal characteristic curve, a target value on the signal characteristic curve, which has a predetermined optimum recording power, is determined to be an optimum recording power. The signal characteristics value is asymmetric in this example.

FIGS. 2A and 2B illustrate a case in which an optimum recording power cannot be determined. FIG. 2A shows the relation between the recording power and the jitter, and FIG. 2B shows the characteristics of the recording power and the recording signal. With reference to FIG. 2A, the optimum recording power Po is set when the jitter is at a minimum level. FIG. 2B shows the optimum recording power in a saturation area which does not guarantee linearity of the recording signal curve. In this case, the optimum recording power cannot be obtained, because the recording power varies greatly from P1 to P2 according to varying recording signal characteristic values in the saturation area at the target value. Therefore, an accurate optimum recording power corresponding to the target signal characteristic value cannot be determined.

### SUMMARY OF THE INVENTION

Aspects of the present invention provide a method of determining an optimum recording power using a recording power at a saturation point of the recording signal characteristics, and an optical recording/reproducing apparatus using the same.

Additional aspects and/or advantages of the invention will be set forth in part in the description which follows and, in part, will be obvious from the description, or may be learned by practice of the invention.

According to an aspect of the present invention, there is provided a method to determine an optimum recording power with respect to a rewritable optical recording medium with multiple layers, the method comprising: writing a recording signal to an unrecorded area of a power calibration area (PCA) of the rewritable optical recording medium using a predetermined recording power, and then measuring characteristics of the recording signal; determining whether or not the measured recording signal characteristics have a saturation area; computing a recording power at a saturation point of the recording signal characteristics when the recording signal characteristics have the saturation area; and determining an optimum recording power by multiplying the recording power at the saturation point by a predetermined value.

According to an aspect of the present invention, determining the optimum recording power may, although not necessarily, include searching for the unrecorded area of the PCA block and erasing the PCA block when the unrecorded area does not exist.

According to an aspect of the present invention, determining the optimum recording power may, although not necessarily, include increasing the predetermined recording power when the recording signal characteristics do not have the saturation area.

According to an aspect of the present invention, the predetermined value may, although not necessarily, be determined according to the type of the optical recording medium, and may, although not necessarily, be pre-stored in the optical recording medium.

According to an aspect of the present invention, the recording signal characteristics may, although not necessarily, linearly increase according to the increase of the recording power before the saturation point, and linearly decrease according to the increase of the recording power after the saturation point.

According to an aspect of the present invention, the recording signal characteristics may, although not necessarily, comprise one of asymmetry signal characteristics and beta signal characteristics.

According to another aspect of the present invention, there is provided an optical recording and reproducing apparatus to determine an optimum recording power with respect to a rewritable optical recording medium with a plurality of layers, the optical recording and reproducing apparatus comprising: a pickup to write a recording signal to an unrecorded area of a power calibration area (PCA) of the rewritable optical recording medium using a predetermined recording power, and then reading the recoding signal; a reproducing processor to digitalize the read recording signal; a measuring part to measure characteristics of the digitalized recording signal; a determining part to determine whether or not the measured recording signal characteristics have a saturation area; and a computing part to compute a recording power at a saturation point of the recording signal characteristics when the recording signal characteristics have the saturation area and to determine an optimum recording power by multiplying the recording power at the saturation pint by a predetermined value.

According to an aspect of the present invention, the optical recording and reproducing apparatus may, although not necessarily, further comprise a searching part to search the unrecorded area of the PCA.

According to an aspect of the present invention, the optical recording and reproducing apparatus may, although not necessarily, further comprise a controller to control such that the recording power is increased when the signal characteristics do not have the saturation area, and also to control the pickup to erase the PCA when the unrecorded area does not exist.

According to an aspect of the present invention, the predetermined value may, although not necessarily, be obtained according to the type of the optical recording medium, and may, although not necessarily, be pre-stored in the rewritable optical recording medium.

According to an aspect of the present invention, the recording signal characteristics may, although not necessarily, linearly increase according to the increase of the recording power before the saturation point, and linearly decrease according to the increase of the recording power after the saturation point.

According to an aspect of the present invention, the recording signal characteristics may, although not necessarily, comprise one of asymmetry signal characteristics and beta signal characteristics.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIGS. 1A and 1B are graphs illustrating a conventional method of determining an optimum recording power using a linear area of a signal characteristic line;

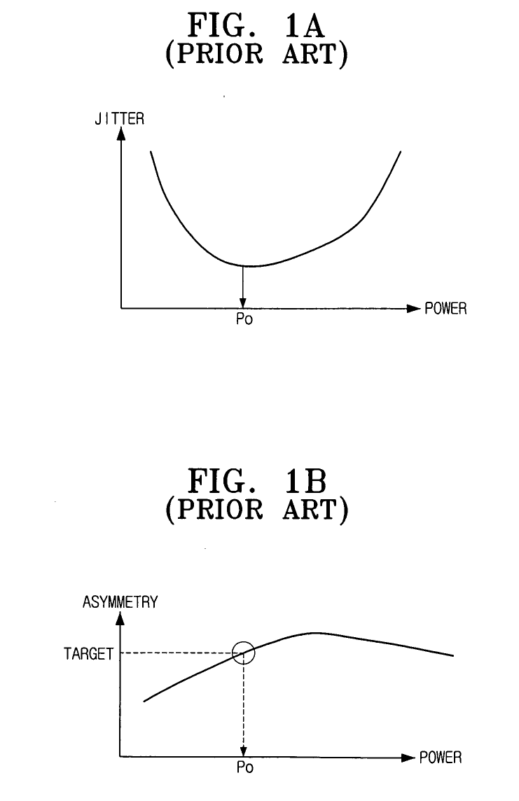

FIGS. 2A and 2B are graphs illustrating a conventional example where the optimum recording power cannot be determined;

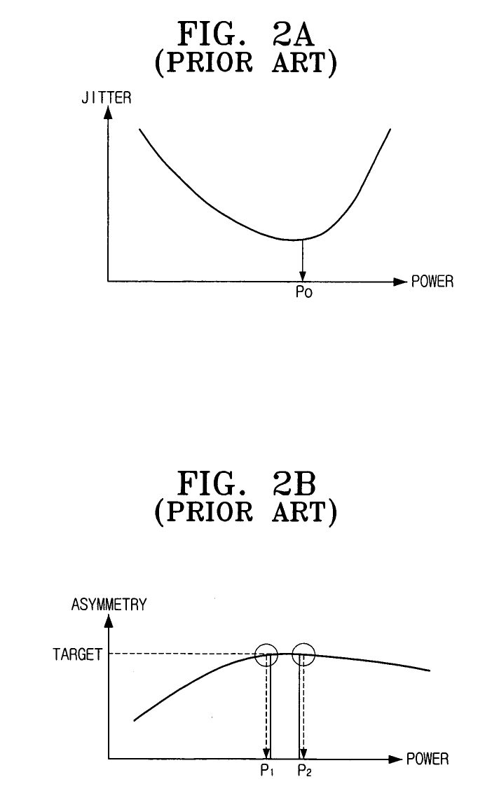

FIG. 3 is a flowchart explaining a method of determining an optimum recording power according to an embodiment of the present invention;

FIGS. 4A and 4B are graphs illustrating a saturation area of a signal characteristic line;

FIGS. 5A and 5B are graphs illustrating a method of calculating an optimum recording power; and

FIG. 6 is a diagram of an optical recording and reproducing apparatus according to an embodiment of the present invention.

### DETAILED DESCRIPTION OF THE EMBODIMENT

Reference will now be made in detail to the present embodiments of the present invention, examples of which are illustrated in the accompanying drawings, wherein like reference numerals refer to the like elements throughout. The embodiments are described below in order to explain the present invention by referring to the figures.

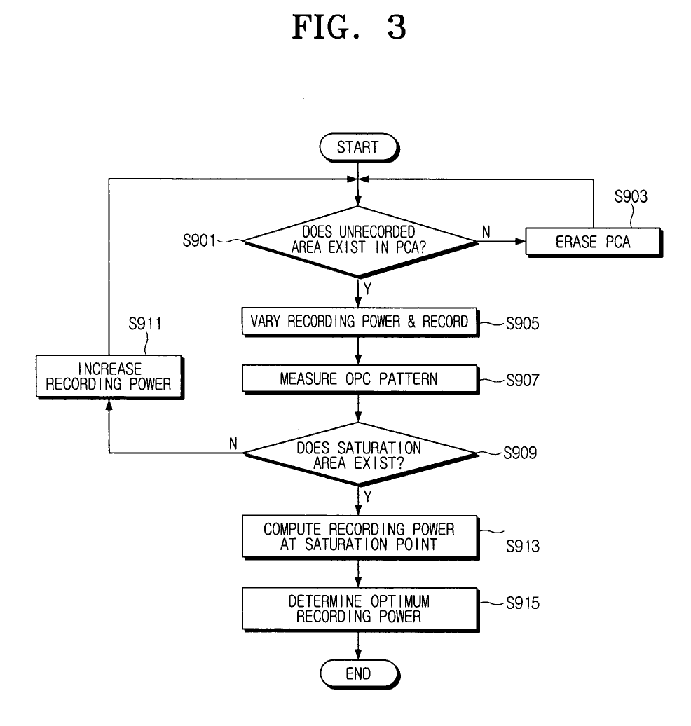

FIG. 3 is a flowchart explaining a method of determining an optimum recording power according to an embodiment of the present invention. This embodiment is particularly applicable to the process of recording data in a rewritable optical recording medium with multiple recording layers, but is not limited thereto. Further, it is understood that aspects of the method can be implemented using software or firmware for use in one or more processors.

Referring to FIG. 3, it is first determined if an unrecorded area exists in the power calibration area (PCA) (S901). With the optical recording medium inserted in the optical recording and reproducing apparatus, according to an input recording command, a PCA for optimum power calibration (OPC) is detected to obtain an optimum recording power. The OPC is performed in a block-wise basis, and PCA blocks with no previous OPC operation are chosen first for OPC.

Therefore, the unrecorded area is first detected in the PCA. When the optical recording medium is a DVD, for example, information about the area with no previous OPC operation is stored in the recording management area (RMA).

When the unrecorded area does not exist in the detected PCA block, a PCA block is erased (S903) and the existence of the unrecorded area of the PCA is detected (S901). In this case, the PCA block is erased by a predetermined eraser power.

After operation S901, data is recorded onto the optical recording medium with a predetermined recording power (S905). However, operations S901 and S903 need not be implemented in all aspects of the invention.

Next, recording signal characteristics are measured from the PCA block which has the data-recorded area (S907). The measurement of the signal characteristics are then approximated by polynomial functions, such as, but not limited to, quadratic equations. The signal characteristics as measured have a saturation point such that the signal characteristics increase before the saturation point while the signal characteristics decrease after the saturation point. As a result, signal characteristics, such as asymmetry signal characteristics and beta signal characteristics may be obtained.

It is then determined whether the measured signal characteristics have a saturation area (S907).

If the measured signal characteristics do not have a saturation area, recording power is increased (S911). Accordingly, data is recorded onto the optical recording medium at an increased recording power, and characteristics of the recording signal are measured to determine again whether or not the measured signal characteristics have a saturation area by repeating operations S901, S905, S907.

If the measured signal characteristics have a saturation area, the recording power at the saturation point is calculated (S913).

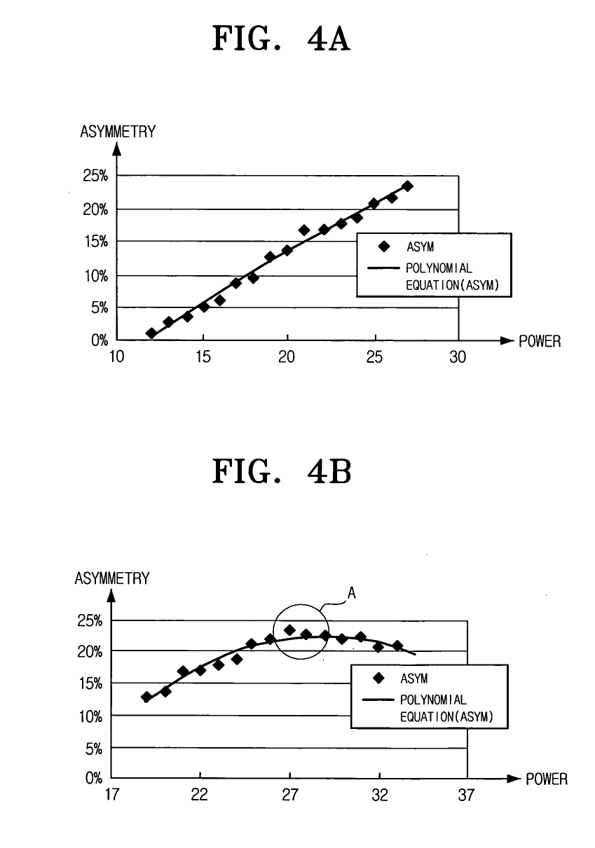

FIGS. 4A and 4B are graphs illustrating a saturation area of a signal characteristic line. FIG. 4A graphically shows signal characteristics which have no saturation area, while FIG. 4B graphically shows signal characteristics which have a saturation area. A horizontal axis represents a recording power, and a longitudinal axis represents asymmetry signal characteristics. Referring to FIG. 4A, with a recording power ranging approximately from 10 mW to 30 mW, the asymmetry signal characteristics as measured do not have a saturation area.

FIG. 4B shows an example having a higher recording power than the example shown in FIG. 4A, with a curve of asymmetry signal characteristics measured at a recording power ranging approximately from 17 mW to 37 mW.

As shown in FIG. 4B, in the data recording onto a rewritable optical recording medium having multiple layers, the characteristic curve of the recording signal has a saturation area A at roughly 28 mW which linearly increase according to the recording power increase before the saturation point, but linearly decrease according to the recording power increase after the saturation point. Accordingly, at a recording power of about 17 mW˜37 mW, approximately 28 mW of recording power at the saturation point can be calculated, which is equivalent to approximately 23% of the asymmetry signal characteristic value.

When the measured signal characteristics do not have saturation area as shown in FIG. 4A, the recording power is increased so that a saturation point can be detected. When the measured signal characteristics have a saturation area, a recording power corresponding to a signal characteristic value at the saturation point is calculated using the signal characteristic value at the saturation point.

Next, an optimum recording power is determined using the recording power at a saturation point of the measured signal characteristics (S915). The optimum recording power to obtain an optimum recording signal is determined by multiplying the recording power at the saturation point by a predetermined value.

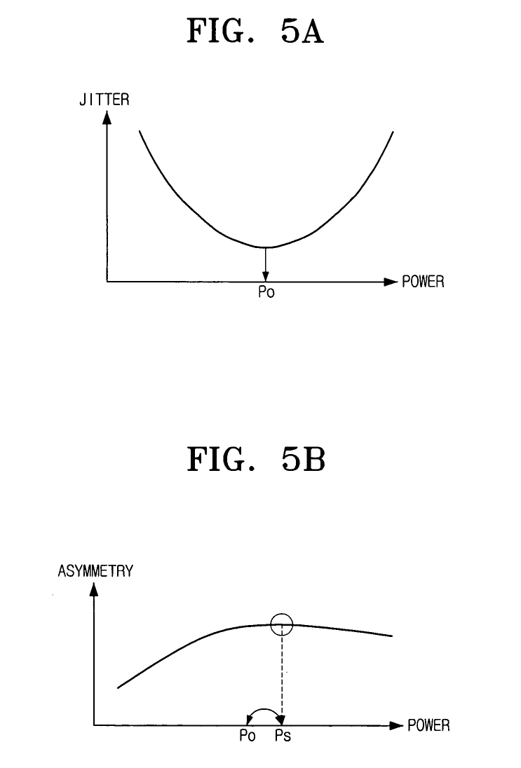

FIGS. 5A and 5B show a method of calculating an optimum recording power according to one embodiment of the present invention. FIG. 5A graphically shows the relation between the recording power and the jitter, and FIG. 5B graphically shows the signal characteristics of the recording power and the asymmetry signal characteristics. The symbol Po represents the optimum recording power, and Ps represents the recording power at a saturation point.

Referring to FIG. 5A, the optimum recording power Po is set when the jittering, which represents error of the signal read from the optical recording medium, is at a minimum level. Referring to FIG. 5B, the recording power at a saturation point Ps of the asymmetry signal characteristic curve is calculated, and the optimum recording power is obtained by multiplying the Ps by a predetermined value. The optimum recording power is calculated by the following equation:
P₀=kₛPₛ Equation 1

where Po is the optimum recording power, and Ps is the recording power at a saturation point. ‘k’ refers to real number.

More specifically, the ‘k’ is determined experimentally, and respectively given according to the type of optical recording medium. The ‘k’ is pre-stored in the recording management area (RMA) and read from the RMA for use in calculating a recording power at a saturation point. Alternatively, the ‘k’ can be stored at the recording/reproducing apparatus and recalled according to a determined type of optical medium.

With reference to the equation 1, the ‘k’ is smaller than ‘1’ when the optimum recording power is smaller than the recording power at the saturation point. The ‘k’ is larger than ‘1’ when the optimum recording power is larger than the recording power at the saturation point. The ‘k’ is ‘1’ when the optimum recording power matches the recording power at the saturation point.

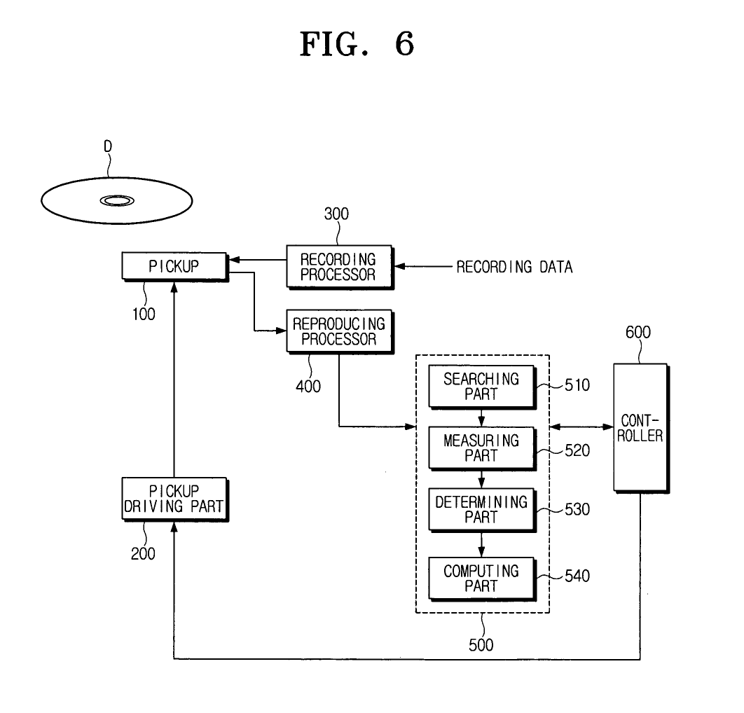

FIG. 6 shows an optical recording and reproducing apparatus according to one embodiment of the present invention. The optical recording and reproducing apparatus incorporates a method according to one embodiment of the present invention, which determines an optimum recording power to record data onto a optical recording medium with multiple layers D. The optical recording medium D may, for example, be a DVD-RW dual layer disc. However, it is understood that other optical media may be used, and that single layer media are usable.

Referring to FIG. 6, the optical recording and reproducing apparatus comprises a pickup 100, a pickup driving part 200, a recording processor 300, a reproducing processor 400, a recording power determining part 500, and a controller 600. The pickup 100 is driven by the pickup driving part 200 to read out data from the optical recording medium D and transmits the data in an electric signal form to the reproducing processor 400. The reproducing processor 400 may perform numerous operations, including digital signal processing such as gain control on the electric signal output from the pickup 100, RF signal processing such as equalization, A/D conversion, and error correction and extension, and accordingly outputs reproducible data. The recording processor 300 outputs incoming data for recording, and the pickup 100 records the data from the recording processor 300 onto the optical recording medium D.

The recording power determining part 500 comprises a searching part 510, a measuring part 520, a determining part 530, and a computing part 540 to determine the optimum recording power for recording data onto the optical recording medium D, according to the saturation characteristics of the recording signal.

The searching part 510 locates an unrecorded area of the PCA block. More specifically, the searching part 510 may locate the unrecorded area of the PCA block using information about areas without previous OPC operation as stored in the RMA. Alternatively, the searching part 510 may locate the unrecorded area of the PCA block using the signal of the PCA block which is processed at the reproducing processor 400.

When there is no unrecorded area in the PCA block, the controller 600 controls the pickup driving part 200 so that a PCA block is erased with a predetermined erase power. As a result, the pickup 100, under the control of the pickup driving part 200, erases the PCA block.

The measuring part 520 measures signal characteristics using the reproduced signal of the PCA recording signal which is digitalized at the reproducing processor 400. The measured signal characteristics have a saturation point such that the signal characteristics linearly increase according to the recording power increase before the saturation point, but linearly decrease according to the recording power increase after the saturation point. The measured signal characteristics may comprise asymmetry signal characteristics and beta signal characteristics, but are not limited thereto.

The determining part 530 determines whether the measured signal characteristics have a saturation area. If not, the controller 600 controls such that the recording power is increased.

The computing part 540 computes recording power at the saturation point of the signal characteristic curve, and determines an optimum recording power using the recording power at the saturation point. When the determining part 530 determines that the measured signal characteristics have a saturation area, the computing part 540 computes a recording power at the saturation point using the signal characteristic value at the saturation point.

The computing part 540 then determines an optimum recording power, by multiplying the computed recording power at the saturation point by a predetermined value ‘k’. While not required in all aspects, the predetermined value ‘k’ may be obtained by the experiments, and respectively given according to the type of the optical recording medium in use. The predetermined value ‘k’ is pre-stored in the optical recording medium D and used in computing an optimum recording power when the recording power at the saturation point is computed.

Furthermore, the predetermined value ‘k’ is smaller than ‘1’ when the optimum recording power is smaller than the recording power at the saturation point, and is larger than ‘1’ when the optimum recording power is larger than the recording power at the saturation point. When the optimum recording power matches the recording power at the saturation point, the predetermined value ‘k’ is ‘1’.

The controller 600 controls the overall components of the optical recording and reproducing apparatus. More specifically, the controller 600 controls such that the recording power is increased when it is determined that the measured signal characteristics do not have a saturation area, and controls the pickup driving part 200 to erase the corresponding PCA block when the unrecorded area does not exist in the PCA block.

As described above, aspects of the invention provide an optimum recording power is determined by using the saturation point of the recording signal characteristic curve such that optimum recording power can be accurately obtained even when the optimum recording power is located in the saturation area of the recording signal characteristic curve. As a result, recording quality of the optical recording medium D is improved.

Although a few embodiments of the present invention have been shown and described, it would be appreciated by those skilled in the art that changes may be made in this embodiment without departing from the principles and spirit of the invention, the scope of which is defined in the appended claims and their equivalents.

What is claimed is:

1. A method of determining an optimum recording power of a rewritable optical recording medium with multiple layers, the method comprising:
writing a recording signal to an unrecorded area of a power calibration area (PCA) block of the rewritable optical recording medium using a predetermined recording power, and then measuring the recording signal characteristics;
determining whether the measured recording signal characteristics have a saturation area at which the recording signal characteristics no longer vary linearly;
computing a recording power at a saturation point of the recording signal characteristics within the saturation area when the recording signal characteristics are determined to have the saturation area; and
determining an optimum recording power by multiplying the computed recording power at the saturation point by a predetermined value.

2. The method as claimed in claim 1, further comprising searching for the unrecorded area of the PCA block and erasing the PCA block when the unrecorded area does not exist.

3. The method as claimed in claim 1, further comprising searching first for the unrecorded area of the PCA block that has not been previously used to determine the optimum recording power.

4. The method as claimed in claim 3, wherein information about the PCA block that has not been previously used to determine the optimum recording power is stored in a recording management area of the rewritable optical recording medium.

5. The method as claimed in claim 1, further comprising increasing the predetermined recording power when the recording signal characteristics do not have the saturation area, until the recording signal characteristics do have the saturation area.

6. The method as claimed in claim 1, wherein the predetermined value is determined according to a type of the rewritable optical recording medium, and pre-stored in the rewritable optical recording medium.

7. The method as claimed in claim 6, wherein the predetermined value is pre-stored in a recording management area of the rewritable optical recording medium.

8. The method as claimed in claim 1, wherein the predetermined value is determined according to a type of rewritable optical recording medium, and pre-stored in an optical recording and reproducing apparatus.

9. The method as claimed in claim 1, wherein the recording signal characteristics linearly increase according to an increase of the recording power before the saturation point, and linearly decrease according to an increase of the recording power after the saturation point.

10. The method as claimed in claim 9, wherein the recording signal characteristics comprise one of asymmetry signal characteristics and beta signal characteristics.

11. The method as claimed in claim 1, wherein the optimum recording power represents when an error of read signals reproduced from the rewritable optical recording medium is at a minimum.

12. An optical recording and reproducing apparatus to determine an optimum recording power of a rewritable optical recording medium with multiple layers, the optical recording and reproducing apparatus comprising:
a pickup to write a recording signal to an unrecorded area of a power calibration area (PCA) block of the rewritable optical recording medium using a predetermined recording power, and to read the written recording signal;
a reproducing processor to digitalize the read recording signal;
a measuring part to measure recording signal characteristics of the digitalized recording signal;
a determining part to determine whether the measured recording signal characteristics have a saturation area at which the characteristics do not vary linearly with changes in recording power; and
a computing part to compute a recording power at a saturation point of the recording signal characteristics when the recording signal characteristics have the saturation area and to determine the optimum recording power by multiplying the recording power at the saturation point by a predetermined value.

13. The apparatus as claimed in claim 12, wherein the pickup transmits the read recording signal in an electric signal form to the reproducing processor.

14. The apparatus as claimed in claim 12, further comprising a searching part to search for the unrecorded area of the PCA block.

15. The apparatus as claimed in claim 14, wherein the searching part searches first for the unrecorded area of the PCA block that has not been previously used to determine the optimum recording power.

16. The apparatus as claimed in claim 15, wherein information about the PCA block that has not been previously used to determine the optimum recording power is stored in a recording management area of the rewritable optical recording medium.

17. The apparatus as claimed in claim 14, wherein the searching part locates the unrecorded area of the PCA block by using the read recording signal processed by the reproducing processor.

18. The apparatus as claimed in claim 12, further comprising a controller to control such that the recording power is increased when the signal characteristics do not have the saturation area, and to control the pickup to erase the PCA block when the unrecorded area does not exist.

19. The apparatus as claimed in claim 12, wherein the predetermined value is obtained according to a type of the optical recording medium, and pre-stored in the optical recording medium.

20. The apparatus as claimed in claim 19, wherein the predetermined value is pre-stored in a recording management area of the rewritable optical recording medium.

21. The apparatus as claimed in claim 12, wherein the predetermined value is obtained according to a type of the optical recording medium, and pre-stored in the optical recording and reproducing apparatus.

22. The apparatus as claimed in claim 12, wherein the recording signal characteristics linearly increase according to an increase of the recording power before the saturation point, and linearly decrease according to an increase of the recording power after the saturation point.

23. The apparatus as claimed in claim 22, wherein the recording signal characteristics comprise one of asymmetry signal characteristics and beta signal characteristics.

24. The apparatus as claimed in claim 12, wherein the optimum recording power represents when an error of the read recording signals is at a minimum.

25. A method of determining an optimum recording power of a rewritable optical recording medium, the method comprising:
measuring recording signal characteristics for a range of recording powers;
computing a relationship between the recording power and the recording signal characteristics to determine a recording power at a saturation point of the measured recording signal characteristics at which the recording signal characteristics no longer vary linearly; and
determining an optimum recording power by multiplying the recording power at the saturation point by a predetermined value.

26. The method as claimed in claim 25, further comprising searching for an unrecorded area of a power calibration area (PCA) block in which to measure the recording signal characteristics.

27. The method as claimed in claim 25, further comprising searching first for the unrecorded area of the PCA block that has not been previously used to determine the optimum recording power.

28. The method as claimed in claim 27, wherein information about the PCA block that has not been previously used to determine the optimum recording power is stored in a recording management area of the rewritable optical recording medium.

29. The method as claimed in claim 25, wherein the predetermined value is determined according to a type of the rewritable optical recording medium, and pre-stored in the rewritable optical recording medium.

30. The method as claimed in claim 29, wherein the predetermined value is pre-stored in a recording management area of the rewritable optical recording medium.

31. The method as claimed in claim 25, wherein the predetermined value is determined according to a type of the rewritable optical recording medium, and pre-stored in an optical recording and reproducing apparatus.

32. The method as claimed in claim 25, wherein the recording signal characteristics linearly increase according to an increase of the recording power before the saturation point, and linearly decrease according to an increase of the recording power after the saturation point.

33. The method as claimed in claim 32, wherein the recording signal characteristics comprise one of asymmetry signal characteristics and beta signal characteristics.

34. The method as claimed in claim 25, wherein the optimum recording power represents when an error of read signals reproduced from the rewritable optical recording medium is at a minimum.

35. A computer readable medium encoded with the method of claim 1 implemented by one or more computers.

36. A computer readable medium encoded with the method of claim 25 implemented by one or more computers.

37. An optical recording and/or reproducing apparatus to determine an optimum recording power of a rewritable optical recording medium, the apparatus comprising:
a pickup to write a recording signal to an unrecorded area of a power calibration area (PCA) block of the rewritable optical recording medium using a predetermined recording power, and to read the written recording signal;
a recording power determining part to determine the optimum recording power at a saturation area at which measured recording signal characteristics of the recording signal do not vary linearly with changes in recording power, by multiplying a recording power at a saturation point in the saturation area by a predetermined value; and a controller to control the pickup to record data to the rewritable optical recording medium according to the determined optimum recording power.

38. The apparatus as claimed in claim 37, further comprising a searching part to search for an unrecorded area of the PCA block, and the recorded signal is recorded in the unrecorded area.

39. The apparatus as claimed in claim 38, wherein information about the PCA block that has not been previously used to determine the optimum recording power is stored in a recording management area of the rewritable optical recording medium, and the searching part detects the unrecorded part according to the information.

40. The apparatus as claimed in claim 38, wherein the searching part locates the unrecorded area of the PCA block by using a read recording signal processed by the reproducing processor.

41. The apparatus as claimed in claim 37, wherein the controller controls the pickup such that the recording power is increased when the signal characteristics do not have the saturation area, and to control the pickup to erase the PCA block when the unrecorded area does not exist.

42. The apparatus as claimed in claim 37, wherein the recording signal characteristics linearly increase according to an increase of the recording power before the saturation point, and linearly decrease according to an increase of the recording power after the saturation point.

43. The apparatus as claimed in claim 37, wherein the optimum recording power represents when an error of the read recording signals is at a minimum.

44. The apparatus as claimed in claim 37, wherein the recording power determining comprises a measuring part to measure the recording signal characteristics of the digitalized recording signal.

45. The apparatus as claimed in claim 37, wherein the recording power determining part comprises a determining part to determine whether the measured recording signal characteristics have the saturation area.

46. The apparatus as claimed in claim 37, wherein the recording power determining part comprises a computing part to compute the recording power at the saturation point of the recording signal characteristics when the recording signal characteristics have the saturation area and to determine the optimum recording power by multiplying the recording power at the saturation point by a predetermined value.

47. The apparatus as claimed in claim 37, wherein the predetermined value is obtained according to a type of the optical recording medium, and pre-stored in the optical recording medium.

48. The apparatus as claimed in claim 47, wherein the predetermined value is pre-stored in a recording management area of the rewritable optical recording medium.

49. The apparatus as claimed in claim 37, wherein the predetermined value is obtained according to a type of the optical recording medium, and pre-stored in the optical recording and reproducing apparatus.
